(19) United States
(12) Patent Application Publication
(10) Pub. No.: US 2018/0354349 A1
(43) Pub. Date: Dec. 13, 2018

(54) DOOR ASSEMBLY WITH SPLIT CARRIER MODULE

(71) Applicant: Magna Closures Inc., Newmarket (CA)

(72) Inventors: Raymond Edward Fortin, Newmarket (CA); Eric V. Kalliomaki, Uxbridge (CA)

(21) Appl. No.: 15/997,087

(22) Filed: Jun. 4, 2018

Related U.S. Application Data
(60) Provisional application No. 62/518,076, filed on Jun. 12, 2017.

(51) Int. Cl. B60J 5/04

(52) U.S. Cl. CPC B60J 5/0463; B60J 5/0418; B60J 5/0416

(57) ABSTRACT

A carrier module for a motor vehicle having inner and outer panels defining a door panel structure with an internal door cavity is provided. The carrier module includes a pair of carrier members operably coupled to one another. The carrier members are configured for substantially free movement relative to one another to facilitate installation of the carrier members separately from one another into the internal door cavity through an opening formed in the inner panel.

### CROSS-REFERENCE TO RELATED APPLICATION

This application claims the benefit of U.S. Provisional Application Ser. No. 62/518,076, filed Jun. 12, 2017, which is incorporated herein by reference in its entirety.

### FIELD

The present disclosure relates generally to vehicle door assemblies, and more particularly to a carrier module of a door assembly having a water/sound barrier and a pair of carrier members, with at least one of the carrier members being detached from the barrier member for movement relative to the other carrier member.

### BACKGROUND

This section provides background information related to the present disclosure which is not necessarily prior art.

In many motor vehicle door assemblies, an outer sheet metal door panel and an inner sheet metal door panel are connected together to define an internal door cavity therebetween. An equipment module or sub-assembly, commonly referred to as a carrier module, or simply carrier, is often mounted to the inner door panel within the internal door cavity. The carrier typically functions as a water/sound barrier and supports various door hardware components, and further includes window regulator rails permanently fixed to opposite sides thereof, such that the window regulator rails are fixed relative to one another, and wherein the window regulator rails are commonly formed as an integral piece of material with the carrier. The outer periphery of the carrier, including a distance extending between upper and lower surfaces of the carrier and a distance extending between outer surfaces of the fixed window regulator rails, defines an outer peripheral envelope that must be able to be assembled into the internal door cavity between the outer and inner door panels without interfering with any other components, and thus, options for ways in which to assemble the carrier within the internal door cavity are typically limited, and in many cases can prove challenging. Further lending to assembly issues of the carrier within the internal door cavity is the presence of a commonly present impact beam, which typically extends across an opening formed in the inner door panel, making assembly of the carrier through the opening of the inner door panel even more challenging. As such, in some cases, the carrier is required to be assembled to the inner door panel prior to assembling the inner door panel to the outer door panel, which can further complicate assembly and add cost thereto. Further yet, if the carrier is not properly assembled within the cavity, the integrity of the water/sound barrier can be compromised.

In view of the above, there is a need to provide carrier module that can be readily attached to an inner door panel of a door assembly without difficulty and without compromising the ability of the door assembly to provide enhanced side impact resistance and to provide a reliable watertight seal between wet and dry sides of the door assembly.

### SUMMARY

This section provides a general summary of the disclosure and is not intended to be considered a complete and comprehensive listing of the disclosure's full scope or all of its aspects, advantages, objectives and/or features.

In accordance with one aspect, the present disclosure is directed to a door assembly for a motor vehicle configured to include an outer panel, an inner panel, and a carrier module. The outer panel and the inner panel, when connected together, form a door panel structure that is configured to define an internal door cavity. The carrier module is configured to include a pair of carrier members operably coupled to one another via at least one cable. The carrier members are configured for substantially free movement relative to one another to facilitate installation of the carrier members into the internal door cavity through an opening formed in the inner panel.

In accordance with another aspect of the disclosure, the carrier module can further include a barrier member operably coupled to at least one of the carrier members.

In accordance with another aspect of the disclosure, the barrier member can be attached to at least one or both of the carrier members.

In accordance with another aspect of the disclosure, the door assembly can further include an intrusion member disposed and fixed within the internal door cavity.

In accordance with another aspect of the disclosure, at least one of the carrier members can be configured in detached relation from the barrier member for relative movement therewith, such that the at least one detached carrier member can be manipulated and inserted through the opening in the inner door panel independently from the other of the carrier members, thereby simplifying assembly and reducing the cost associated therewith.

In accordance with another aspect of the disclosure, one of the carrier members can be fixed to the barrier member with the other of the carrier members being detached from the barrier member.

In accordance with another aspect of the disclosure, the barrier member can be provided having a hinge to facilitate folding, transporting and assembling carrier module, wherein the hinge can be provided as any suitable hinge, whether via separate hinge members or as a living hinge within the material of the barrier member.

In accordance with another aspect of the disclosure, the barrier member can include a continuous peripheral seal bead configured for selective fixation of the barrier member to the inner door panel.

In accordance with another aspect of the disclosure, the seal bead of the barrier member can be an adhesive material, such as butyl.

In accordance with another aspect of the disclosure, the barrier member can be a continuous sheet of material that is free of hinges.

In accordance with another aspect of the disclosure, the barrier member can be formed of a fluid impervious, sound barrier grade material, such as from a suitable foam, plastic, nonwoven, textile, or the like.

In accordance with another aspect of the disclosure, the barrier member can be formed with integral locating features formed in the material of the barrier member, with the locating features of the barrier member being configured for mating engagement with corresponding locating features on the separate carrier members to facilitate assembly.

In accordance with another aspect of the disclosure, the barrier member can be formed with first pockets configured for mating engagement with second pockets in at least one of the carrier members, wherein the first pockets are configured for receipt of dry-side hardware components therein.

In accordance with another aspect of the disclosure, the opening in the inner panel can be made relatively small compared to the outer peripheral envelop of the carrier module, as fully assembled, due to the ability of being able to manipulate at least one of the carrier members independently from the other carrier member, thus allowing an increased amount of material to be used to form the inner panel without impacting the ease of assembly, and thereby enhancing the side impact resistance of the inner panel and door assembly.

In accordance with another aspect of the disclosure, the sole source of attachment of the carrier members to one another, prior to assembly to the door panel structure, is a flexible member, such as a cable and/or conduit and/or electrical wires, thereby allowing substantially unrestricted relative movement of the carrier members relative to one another during assembly.

In accordance with another aspect of the disclosure, one or both of the window regulator rails on the carrier members can be formed to include a glass run channel.

In accordance with another aspect of the disclosure, a carrier module for a motor vehicle having inner and outer panels defining a door panel structure with an internal door cavity is provided. The carrier module includes a pair of carrier members operably coupled to one another via at least one cable. The carrier members are configured for substantially free movement relative to one another to facilitate installation of the carrier members separately from one another into the internal door cavity through an opening formed in the inner panel.

In accordance with another aspect of the disclosure, the carrier module can include a fluid/sound barrier member configured to close off the opening in the inner panel.

In accordance with another aspect of the disclosure, the barrier member of the carrier module can be operably coupled to at least one or both of the carrier members.

In accordance with another aspect of the disclosure, the barrier member of the carrier module can be foldable along a hinge.

In accordance with another aspect of the disclosure, the carrier members can be provided with integral window regulator rails.

In accordance with another aspect of the disclosure, one or both of the window regulator rails of the carrier module can include a glass run channel.

In accordance with another aspect of the disclosure, the barrier member and pair of carrier members are formed from a polymeric material, such as a plastic material. According to another aspect, the barrier member and one of the pair of carrier members are an integrally monolithic formed structure.

In accordance with another aspect of the disclosure, a method of assembling a carrier module into an internal door cavity extending between inner and outer panels of a motor vehicle door is provided. The method includes providing a carrier module having a pair of carrier members operably coupled to one another via at least one cable, with the carrier members being configured for substantially free movement relative to one another. Further, inserting the carrier members through an opening in the inner panel into the internal door cavity independently from one another and then fixing the carrier members relative to one another within the internal door cavity.

In accordance with another aspect of the disclosure, the method can further include providing the carrier module having a barrier member fixed to one of the carrier members and closing off the opening of the inner panel with the barrier member upon inserting the carrier members into the internal door cavity.

In accordance with another aspect of the disclosure, the method can further include bonding the barrier member to a dry side surface of the inner panel facing an interior of the vehicle.

In accordance with another aspect of the disclosure, the method can further include inserting the carrier members into the internal door cavity while the barrier member is folded and fixed to one of the carrier members to facilitate insertion of the carrier members, and then unfolding the barrier member for fixation to the outer surface of the inner panel after fixing the carrier members in the internal door cavity.

In accordance with another aspect of the disclosure, the method can further include positioning the barrier member relative to the carrier members by aligning and coupling locating features on the carrier members with locating features on the barrier member.

In accordance with another aspect of the disclosure, the method can further include fixing the barrier member to a first one of the carrier members and fixing dry-side electrical components to the first carrier member with the barrier member sandwiched therebetween prior to assembling the carrier module to the vehicle door.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a motor vehicle with a door assembly;

FIG. 2 illustrates a carrier module of the door assembly of FIG. 1 constructed in accordance with one aspect of the disclosure shown in a preassembled state;

FIG. 3 illustrates the carrier module of FIG. 2 in an initial stage of assembly to the door assembly of FIG. 1;

FIG. 4 illustrates the carrier module of FIG. 2 shown in a partially assembled state to the door assembly of FIG. 1;

FIG. 5 illustrates the carrier module of FIG. 2 shown in a fully assembled state to the door assembly of FIG. 1;

FIG. 6 illustrates an exploded view of a portion of the carrier module of FIG. 2;

FIG. 7 illustrates an enlarged cross-sectional view taken generally along the line 7-7 of FIG. 5 showing a carrier member of the carrier module assembled to an inner panel of a door assembly; and

FIG. 8 a view similar to FIG. 7 taken generally along the line 8-8 of FIG. 5.

### DETAILED DESCRIPTION OF EXAMPLE EMBODIMENTS

In general, example embodiments of a door assembly with split carrier module and split carrier module therefor, of the type configured including window regulators to be installed within an internal door cavity of a motor vehicle door assembly and having a barrier member configured to separate a wet side from a dry side of the door assembly, constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

An example two-piece carrier module embodiment disclosed in accordance with one aspect of the disclosure includes a barrier member and a pair of carrier members configured to provide a pre-installed/collapsed arrangement and a post-installed/assembled arrangement, with a pair of window regulators integrally attached to the carrier members, wherein the carrier members are operably coupled to one another via flexible members, such as cables and/or conduits, thereby allowing the carrier members and associated window regulators to be independently moved and positioned relative to one another.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

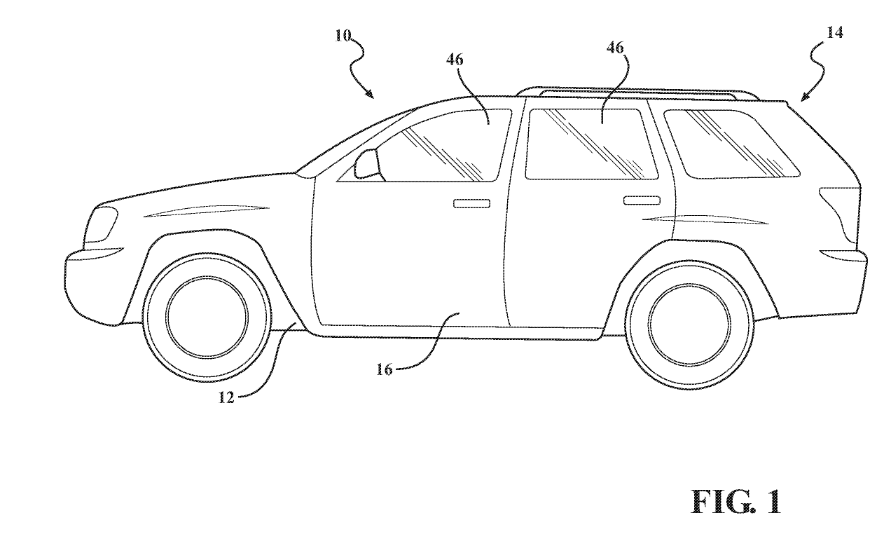

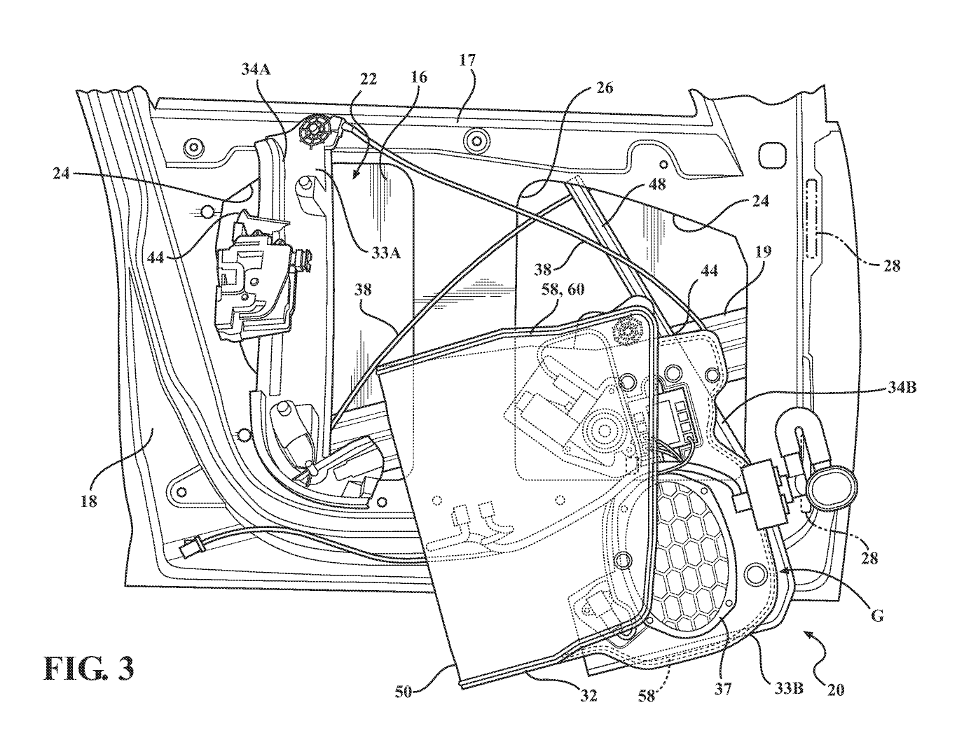

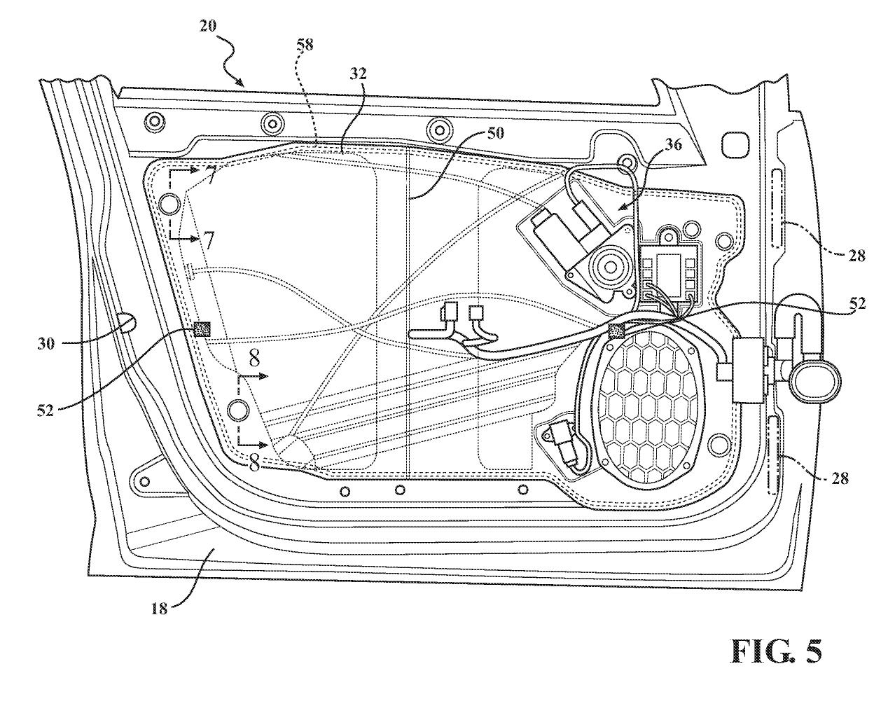

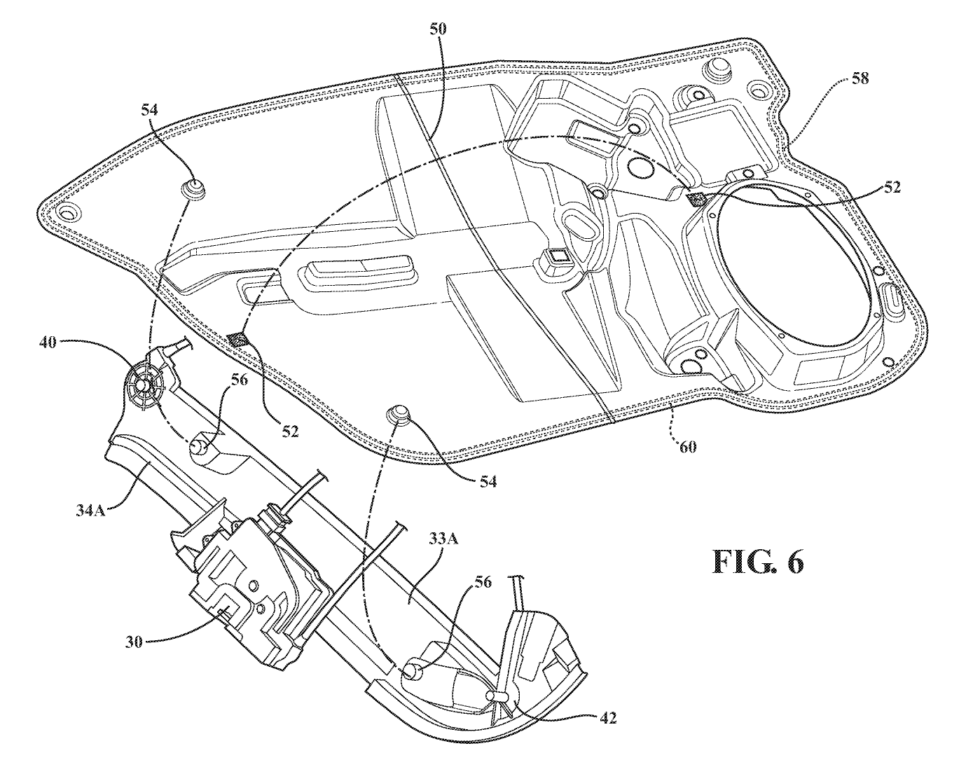

Reference is made to FIG. 1, which shows a door assembly 10 mounted to a body 12 of a motor vehicle 14. The door assembly 10 includes an outer panel 16, an inner panel 18 (FIGS. 3-5), an intrusion member 19 and a split carrier module, referred to hereafter as carrier module 20, shown constructed in accordance with one presently preferred aspect of the disclosure. The production, performance and structural impact resistance of the door assembly 10 is facilitated and enhanced directly as a result of the configuration of the carrier module 20, as discussed further hereafter and as will be readily appreciated by one skilled in the art.

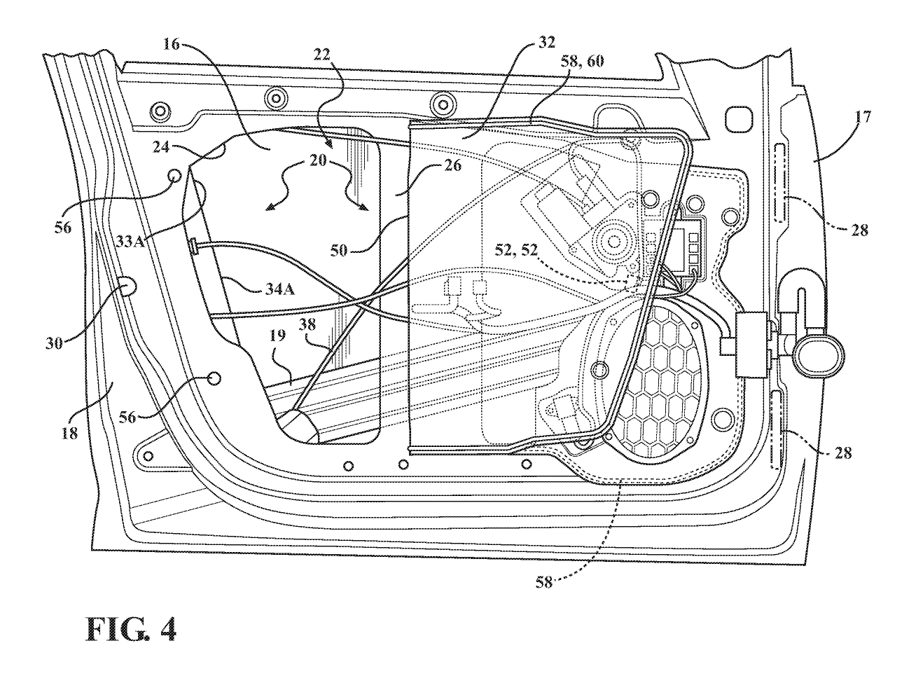

The outer panel 16 forms at least part of the exterior surface of the door assembly 10. The inner panel 18 provides a structural member for the mounting of one or more trim pieces that form an inner surface of the door assembly 10. Some of the inner panel 18 may itself also form part of the inner surface of the door assembly 10, if desired. The outer and inner panels 16, 18 are connected together to provide a door panel structure 17 that forms an internal door cavity 22 (FIGS. 3 and 4) that contains various components of the door assembly 10, including at least a portion of the carrier module 20. To facilitate assembly of the components into the cavity 22, the inner panel 18 has at least one, and shown as a pair of openings 24, by way of example and without limitation. The openings 24 are shown as being formed on opposite sides of the inner panel 18 with a central support member or rail 26 extending therebetween. The central support rail 26 can be formed as an integral, monolithic piece of material with the inner panel 18, thereby rendering the inner panel 18 economical in manufacture and enhancing the structural integrity, strength and side impact resistance of the inner panel 18. Due to the ability of at least some of the individual carrier module components, discussed separately hereafter, to be moved and manipulated relative to one another and due to the relatively small size of the aforementioned individual components of the carrier module 20, in comparison to the size of the assembled carrier module 20, as discussed in more detail below, and further due to the ability to maintain at least a portion of the carrier module 20 externally from the internal door cavity 22, the size of the individual openings 24 needed in the inner panel 18 for assembly of the carrier module 20 can be minimized and can be made smaller than the “as fully assembled” outer periphery of the carrier module 20. As such, the amount and area of material forming the inner panel 18 can be maximized, thereby increasing the side impact strength of the inner panel 18 relative to inner panels having substantially larger central openings.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 17 and pivotally mount a front end of door panel structure 17 (and door assembly 10) to the vehicle body 12. A door latch 30 is mounted to the rear end of door panel structure 17 to permit the releasable closure of door assembly 10 against vehicle body 12. Hinges 28 and door latch 30 act as force transfer members through which forces in door assembly 10 are transmitted to vehicle 14. Such forces include, for example, side-impact forces from another vehicle or object colliding with the vehicle 14.

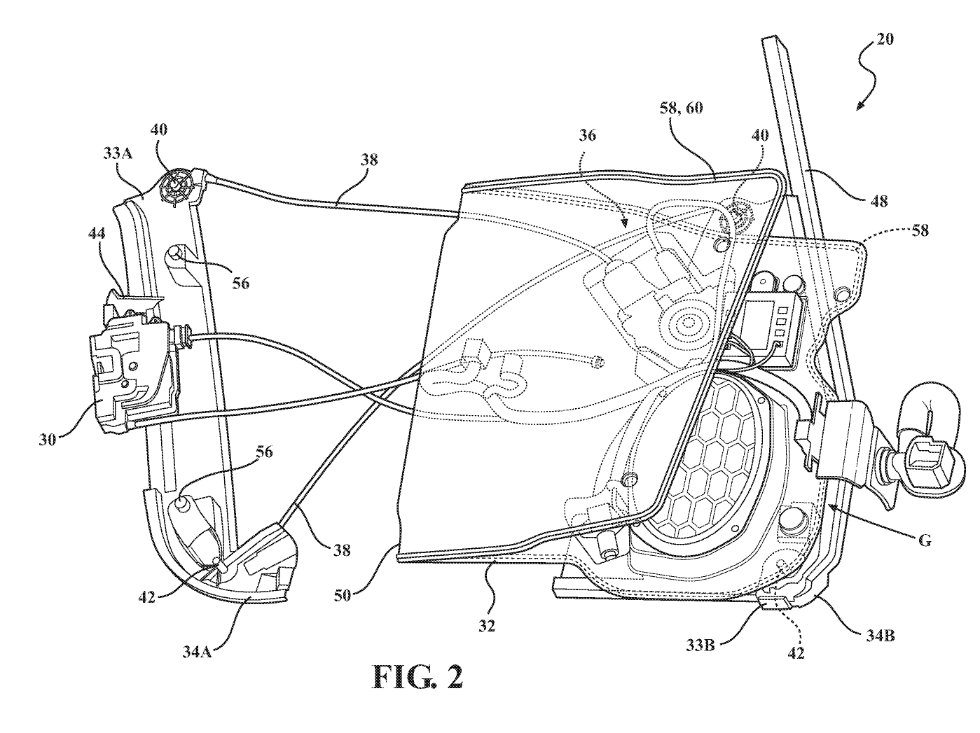

The carrier module 20 is shown to include a barrier member, shown as being a collapsible barrier member 32, by way of example and without limitation, a pair of carrier members 33A, 33B, a pair of window regulator rails 34A, 34B integrally attached to the carrier members 33A, 33B, and a plurality of door hardware components operably mounted to the carrier members 33A, 33B. In an embodiment, the barrier member 32 and pair of carrier members 33A, 33B are formed from a polymeric material, such as a plastic material, which can be manufactured using injection molding techniques for providing a lightweight carrier module 20. In this non-limiting example, at least some of the door hardware includes a power-operated window regulator 36 having an electric motor-driven cable 38, a pair of upper pulleys 40 and lower pulleys 42 (FIG. 2), a pair of lifter plates 44 for moving a window 46 within a pair of glass run channels 48 (one shown), which can be formed integrally as part of the window regulator rails 34A, 34B. Other hardware components shown are well understood by those skilled in the art, and thus, need no explanation, in addition to other components that can be provided, but are not shown.

In accordance with a non-limiting embodiment, barrier member 32, intended to function both as a fluid (water) barrier and as a sound barrier, can be provided as a single-piece panel assembly configured to receive a plurality of the aforementioned powered actuators and door hardware components in integrally formed first pockets 31 contoured to mate with corresponding second pockets formed integrally in the carrier members 33A, 33B. The barrier member 32 can also be configured to allow pass-through of door hardware components in provided for on carrier members 33A, 33B with integrally formed first sockets 35 contoured to mate around corresponding door hardware components i.e. speaker 37 provided in the carrier members 33A, 33B. The barrier member 32 is adapted to be installed in fixed attachment to a surface of the inner panel 18 facing the passenger compartment of the vehicle 14 upon fixing the carrier members 33A, 33B in their respective positions in the internal door cavity 22. The barrier member 32 is preferably collapsible, and is shown as being foldable in half, or substantially in half (meaning less than truly half, but a close approximation thereto, such as about a 40-60% split, or otherwise) via a hinge 50, such as a living hinge formed integrally in the material of the barrier member 32 or other separate mechanical hinge arrangement. Accordingly, it is to be recognized that the hinged barrier member 32 can be formed as a single piece of material (living hinge), or from separated pieces of material hingedly joined to one another (mechanical hinge arrangement). As such, the barrier member 32 can be provided to fold into the desired configuration, preferably to expose one or more of the openings 24, to form a reduced outer peripheral envelop, thereby enhancing the ease of assembly of the carrier members 33A, 33B and associated window regulator rails 34A, 34B and other components into the internal door cavity 22, and in addition, reducing the package size require for shipping and the space needed for storage. To further facilitate releaseably maintaining the barrier member 32 in a folded configuration, the barrier member 32 can be provided with fastener features 52 that releaseably couple to one another while the barrier member 32 is in a folded state, thereby facilitating handling, whereupon the fastener features 52 can be readily and selectively uncoupled from one another during assembly. It is contemplated herein that the fastener features could be provided as a hook-and-loop type fastener, snaps, and the like.

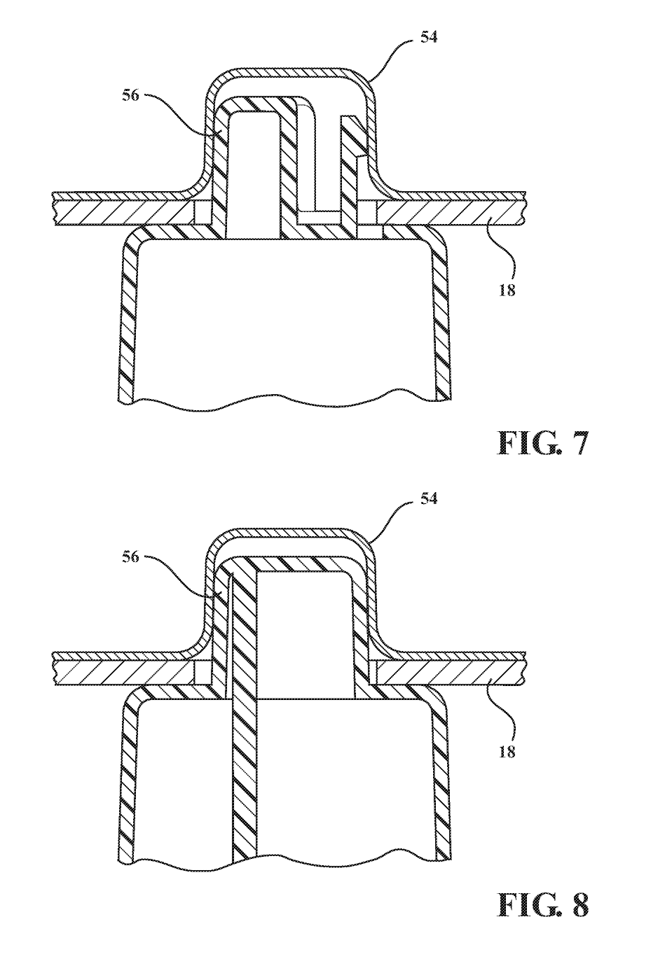

The barrier member 32 can be formed of any suitable fluid/sound barrier material, as desired, in order to meet the necessary specifications, such as a foam, plastic, nonwoven, textile, and/or like materials. Further, in order to facilitate assembly, including ensuring the barrier member 32 is properly located and fixed in sealed relation relative to the inner panel 18, the barrier member 32 can be formed with locating features 54, shown by way of example as female recesses formed integrally in the material of the barrier member 32, configured for mating engagement with corresponding locating features 56, shown by way of example an male protrusions, (FIGS. 7 and 8) provided on at least one of the separate carrier members 33A, 33B, and can further include a peripherally extending seal bead 58. The locating features 54, 56 can be formed to provide a snug, interference fit with one another thereby automatically interlocking with one another upon being pressed into engagement with one another, which also acts to automatically and properly align the separate components (carrier members 33A, 33B and barrier member 32) of the carrier module 20 with one another. The barrier member 32 can be provided integral with at least a portion of one of the separate carrier members 33A, 33B to provide a permanent attachment therewith e.g. barrier member 32 can be integrally formed or attached with carrier members 33B, and located and fixed with carrier member 34B using the above described locating features 54, 56. The seal bead 58 can be provided as any suitable continuous bead of adhesive material capable of maintaining a fluid-tight seal between the barrier member 32 and an outer surface of the inner panel 18, such as butyl, by way of example and without limitation. A selectively removable protective layer 60, sometimes referred to as release paper or release film, and referred to hereafter as release member 60, can be disposed over the seal bead 58 until it is desired to expose the seal bead 58 for bonding with the inner panel 18, thereby protecting the seal bead 58 against unwanted contamination.

Upon manufacture, during storage and while in a preassembly state (after being manufactured but prior to assembly to the door panel structure 17, one of the carrier members 33A and associated window regulator rail 34A is decoupled/detached from the barrier member 32, and thus, from the other carrier member 33B, such that the carrier members 33A, 33B and associated window regulator rails 34A, 34B can be freely manipulated for movement relative to one another. This greatly facilitates assembly and also greatly reduces the package size required for shipping and the space needed for storage, since the carrier members 33A, 33B and associated window regulator rails 34A, 34B can essentially be stacked on one another in overlying relation, with the barrier member 32 manipulated into a folded state, to assume a relatively small outer peripheral envelop. The sole source of attachment of the carrier members 33A, 33B and associated window regulator rails 34A, 34B with one another is a flexible member 38, e.g., a cable and/or conduit and/or electrical wires, such as those needed for operable functioning of various components of the door assembly 10. Accordingly, while in the preassembly state, substantially unrestricted relative movement is provided between the carrier members 33A, 33B and associated window regulator rails 34A, 34B, with the carrier member 33A shown as being decoupled/detached from and being freely movable relative to the barrier member 32 during assembly, with the barrier member 32 being fixed to the other carrier member 33B and associated window regulator rail 34B while in the preassembly state and during assembly. As such, as discussed above, the size of the opening(s) 24 in the inner panel 18 can be made relatively small for insertion of the carrier members 33A, 33B separately from one another and associated window regulator rails 34A, 34B into the internal door cavity 22, thereby allowing for an increased area of material to be provided by the inner panel 18 to optimize the moment of inertia of the panel 18 and side impact resistance of the door assembly 10.

In view of the structural features of the carrier module 20 discussed and illustrated, an improved method of assembling a door assembly 10 for a motor vehicle 14 is provided. The method includes attaching outer and inner panels 16, 18 to one another to define a door panel structure 17 having an internal door cavity 22. Further, providing the carrier module 20 having a pair of carrier members 33A, 33B and associated window regulator rails 34A, 34B operably coupled to one another via at least one flexible member 38, e.g., cable and/or conduit and/or electrical wire, with a barrier member 32 optionally fixed to one of the carrier members 33A, 33B and associated window regulator rails 34A, 34B and being decoupled/detached from the other of the carrier members 33A, 33B and associated window regulator rails 34A, 34B while in a preassembly state. Then, inserting the carrier members 33A, 33B and associated window regulator rails 34A, 34B through an opening 24 of the inner panel 18 and into the internal door cavity 22 independently from one another by moving a first one of the carrier members, such as carrier member 33B and associated window regulator rail 34B, by way of example and without limitation, through the opening 24 and into the internal door cavity 22. It is to be recognized that during insertion of the carrier member 33B with barrier member 32 fixed thereto, barrier member 32 is maintained outside internal door cavity 22, as discussed further below. Then, inserting a second one of the carrier members, such as carrier member 33A and associated window regulator rail 34A, by way of example and without limitation, through the opening 24 and into the internal door cavity 22. By being able to assemble the first and second carrier members 33A, 33B and associated window regulator rails 34A, 34B into the internal door cavity 22 independently from one another, the handling and positioning to of the carrier members 33A, 33B is made easier and the size of the opening 24 can be minimized, thereby allowing the strength and side impact resistance of the inner panel 18 and resulting door assembly 10 to be maximized. Then, upon locating the carrier members 33A, 33B in the internal door cavity 22, the method includes fixing barrier member 32 in position, wherein the barrier member 32 remains on an interior side of the inner panel 18 and thus, outside the internal door cavity 22 during assembly, which is made possible via a peripheral gap G provided between the carrier member 33B and an outer periphery of barrier member 32. The barrier member 32 can be fixed in position via unfolding the barrier member 32 and pressing a peripherally extending seal bead 58 to an outer surface of the inner panel 18. It is to be recognized that the barrier member 32 could be provided as a separate component in detached relation from the carrier members 33A, 33B, if desired, or as discussed above and illustrated, as being initially fixed to one of the carrier members 33A, 33B, shown as carrier member 33B, and detached from the other of the carrier members 33A, 33B, shown as carrier member 33A, in a preassembly state, until optional subsequent attachment to the other of the carrier members, shown as carrier member 33A, via locating features 54, 56 being brought into nested attachment with one another to bring carrier module 20 to its fully assembled state to door panel structure 17.

It is to be recognized that although the above discussion references glass run channels 48 as being integrally attached to at least one of the window regulator rails 34A, 34B, that the window regulator rails 34A, 34B could be configured for frameless glass use.

While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A carrier module for a motor vehicle door assembly having inner and outer panels defining a door panel structure with an internal door cavity, said carrier module, comprising:
a pair of carrier members operably coupled to one another via at least one cable, said carrier members being configured for substantially free movement relative to one another to facilitate installation of said carrier members independently from one another into the internal door cavity through an opening formed in the inner panel.

2. The carrier module of claim 1, further including a barrier member fixed to at least one of said carrier members.

3. The carrier module of claim 2, wherein said barrier member is fixed to one of said carrier members and detached from the other of said carrier members.

4. The carrier module of claim 3, wherein said barrier member is foldable along a hinge.

5. The carrier module of claim 4, wherein said hinge is a living hinge.

6. The carrier module of claim 4, wherein said barrier member includes fastener features configured for releasable attachment to one another to selectively maintain the barrier member in a folded state.

7. The carrier module of claim 4, wherein said barrier member includes at least one location feature and said carrier member detached from the barrier member includes at least one location feature, said location features of said barrier member and said carrier member being configured for attachment with one another.

8. The carrier module of claim 4, wherein said barrier member includes a seal bead extending about an outer periphery of said barrier member.

9. The carrier module of claim 8, further including a release film releaseably covering said seal bead.

10. The carrier module of claim 1, wherein said carrier members include window regulator rails.

11. A door assembly for a vehicle, comprising:
an outer panel;
an inner panel having at least one opening, said inner panel being connected to said outer panel to form an internal door cavity; and
a carrier module including a pair of carrier members operably coupled to one another via at least one cable, said carrier members being configured for substantially free movement relative to one another to facilitate installation of said carrier members independently from one another into the internal door cavity through said opening formed in the inner panel.

12. The door assembly of claim 11, further including a barrier member permanently fixed to one of said carrier members and detached from the other of said carrier members.

13. The door assembly of claim 12, wherein said barrier member is foldable along a hinge.

14. The door assembly of claim 13, wherein said barrier member is bonded to said inner panel via a seal bead.

15. The door assembly of claim 11, wherein said carrier members include window regulator rails.

16. A method of assembling a carrier module through an opening into an internal door cavity formed between inner and outer panels of a motor vehicle door, comprising:
providing a carrier module having a pair of carrier members operably coupled to one another via at least one cable, said carrier members being freely moveable relative to one another; and
inserting the carrier members through the opening in the inner panel into the internal door cavity independently from one another and fixing the carrier members relative to one another within the internal door cavity.

17. The method of claim 16, further including providing the carrier module having a barrier member fixed to one of the carrier members and inserting the carrier member with the barrier member fixed thereto into the internal door cavity and closing off the opening of the inner panel with the barrier member upon inserting the carrier members into the internal door cavity.

18. The method of claim 17, further including unfolding the barrier member after inserting the carrier members into the internal door cavity.

19. The method of claim 18, further including exposing a seal bead on the barrier member and bonding the barrier member to a dry side surface of the inner panel facing an interior of the vehicle via the seal bead.

20. The method of claim 18 further including coupling locating features on one of the carrier members with locating features on the barrier member upon unfolding the barrier member.
